(19) United States
(12) Patent Application Publication
(10) Pub. No.: US 2006/0271411 A1
(43) Pub. Date: Nov. 30, 2006

(54) Methods and systems for providing an additional subject benefit

(75) Inventors: David James Gregg, Papillion, NE (US); Jill A. Andreasen, Gretna, NE (US); Clark Allen Heitkamp, Elkhorn, NE (US); Gregory A. Schmidt, Omaha, NE (US)

Correspondence Address: MERCHANT & GOULD PC, P.O. BOX 2903, MINNEAPOLIS, MN, 55402-0903, US

(73) Assignee: Mutual of Omaha

(21) Appl. No.: 11/136,870

(22) Filed: May 25, 2005

(51) Int. Cl. G06Q 40/00

(52) U.S. Cl. 705/4

(57) ABSTRACT

Systems and methods are disclosed for providing an additional subject benefit. The disclosed systems and methods may include receiving a first application associated with a first applicant for a first policy and a second application associated with a second applicant for a second policy. Furthermore, the disclosed systems and methods may include approving the first applicant for the first policy, declining the second applicant for the second policy, and transmitting an offer to add the second applicant to the first policy as an additional subject. Furthermore, the disclosed systems and methods may include receiving an acceptance of the offer and adding the second applicant to the first policy as the additional subject.

### BACKGROUND OF THE INVENTION

I. Field of the Invention

The present invention generally relates to methods and systems for providing an additional subject benefit. More particularly, the present invention relates to providing an additional subject benefit based upon qualifying for a first benefit.

II. Background Information

Insurance proposal creation is a process for providing a solicitation for insurance coverage, for example, to individuals or couples. In some situations, however, a proposal/solicitation may cause prospective customers to go to other insurance underwriters for coverage. For example, John and Catherine are a married couple. Catherine is in relatively good health, however, John has insulin-dependent diabetes. The couple knows that there is a good chance one or both will need long-term care services some day and are extremely interested in purchasing long-term care insurance. When the couple learns from a long-term care insurance proposal that while Catherine does qualify for long-term case coverage, John does not qualify for long-term care coverage. In this situation, they may not know what to do. In fact, they may consider looking for coverage elsewhere, for example, from another underwriter. Thus, the conventional strategy is to allow subjects within a couple to qualify individually for insurance coverage. This often causes problems, for example, because the conventional strategy does not provide an alternative proposal if one subject in a couple is turned down for coverage.

In view of the foregoing, there is a need for methods and systems for providing an additional subject benefit. Furthermore, there is a need for providing an additional subject benefit based upon qualifying for a first benefit.

### SUMMARY OF THE INVENTION

Consistent with embodiments of the present invention, systems and methods are disclosed for providing an additional subject benefit.

In accordance with one embodiment, a method for providing an additional subject benefit comprises determining that the additional subject benefit is not available based on an analysis of an application, receiving data indicating a response of an applicant to the additional subject benefit not being available, and issuing a policy without the additional subject benefit if the received data indicates that the applicant wants the policy without the additional subject benefit.

According to another embodiment, a method for providing an additional subject benefit comprises determining that an applicant associated with a policy qualifies for coverage under the policy, receiving a second application to add an additional subject to the policy, increasing a premium level associated with the policy, and adding the additional subject benefit to the policy.

In accordance with yet another embodiment, a method for providing an additional subject benefit comprises receiving a first application associated with a first applicant for a first policy and a second application associated with a second applicant for a second policy, approving the first applicant for the first policy, declining the second applicant for the second policy, transmitting an offer to add the second applicant to the first policy as an additional subject, receiving an acceptance of the offer, and adding the second applicant to the first policy as the additional subject.

In accordance with yet another embodiment, a method for providing an additional subject benefit comprises receiving a claim for a first benefit associated with a policy, determining that an applicant qualifies for the first benefit, and determining that the applicant qualifies for the additional subject benefit associated with the policy based on determining that the applicant qualifies for the first benefit.

In accordance with yet another embodiment, a computer-readable medium which stores a set of instructions which when executed performs a method for providing an additional subject benefit, the method executed by the set of instructions comprising determining that the additional subject benefit is not available based on an analysis of an application, receiving data indicating a response of an applicant to the additional subject benefit not being available, and issuing a policy without the additional subject benefit if the received data indicates that the applicant wants the policy without the additional subject benefit.

In accordance with yet another embodiment, a computer-readable medium which stores a set of instructions which when executed performs a method for providing an additional subject benefit, the method executed by the set of instructions comprising determining that an applicant associated with a policy qualifies for coverage under the policy, receiving a second application to add an additional subject to the policy, increasing a premium level associated with the policy, and adding the additional subject benefit to the policy.

In accordance with yet another embodiment, a computer-readable medium which stores a set of instructions which when executed performs a method for providing an additional subject benefit, the method executed by the set of instructions comprising receiving a first application associated with a first applicant for a first policy and a second application associated with a second applicant for a second policy, approving the first applicant for the first policy, declining the second applicant for the second policy, transmitting an offer to add the second applicant to the first policy as an additional subject, receiving an acceptance of the offer, and adding the second applicant to the first policy as the additional subject.

In accordance with yet another embodiment, a computer-readable medium which stores a set of instructions which when executed performs a method for providing an additional subject benefit, the method executed by the set of instructions comprising receiving a claim for a first benefit associated with a policy, determining that an applicant qualifies for the first benefit, and determining that the applicant qualifies for the additional subject benefit associated with the policy based on determining that the applicant qualifies for the first benefit.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a flow chart of a first exemplary method for providing a benefit consistent with an embodiment of the present invention;

FIG. 2 is a flow chart of a second exemplary method for providing a benefit consistent with an embodiment of the present invention;

FIG. 3 is a flow chart of a third exemplary method for providing a benefit consistent with an embodiment of the present invention;

FIG. 4 is a flow chart of a forth exemplary method for providing a benefit consistent with an embodiment of the present invention; and

FIG. 5 is a block diagram of an exemplary benefits system consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding stages to the disclosed methods. Accordingly, the following detailed description does not limit the invention. Instead, the proper scope of the invention is defined by the appended claims.

Systems and methods consistent with embodiments of the present invention provide an additional subject benefit. For example, embodiments of the invention may provide benefits if an insured first subject has an associated second subject and the second subject does not qualify for coverage on their own (e.g. long-term care insurance) or does not want to purchase their own coverage. The first subject and the second subject may comprise any type of associated couple, including, but not limited to a married couple, a domestic partnership, or a civil union. The aforementioned are exemplary, and the first subject and the second subject may comprise any type of association.

Consistent with an embodiment of the invention, for example, a first subject of a couple may purchase a policy to cover the first subject. The policy may comprise any type of agreement including, but not limited to, an insurance policy of any variety, long-term care coverage or otherwise. The name of a second subject of the couple may be added to the policy under an additional subject benefit provision. For example, when the first subject (i.e. primary insured) qualifies for benefits under the policy, an additional subject benefit may be added to the applicable daily or monthly benefit amount payment to the first subject. For example, if the first subject receives a $1,000 monthly benefit (i.e. a first benefit), the additional subject benefit may provide an additional percentage, such as 60%, thereby by adding an additional $600 for a total of $1,600. The entire benefit amount, including the first benefit portion and the additional subject benefit portion, may be included in one check payable to, for example, the first subject.

The additional subject benefit may continue as long as the first benefit is being paid to the first subject, for example, as long as the first subject qualifies for coverage under the policy. The first subject may no longer qualify for coverage under the policy, for example, due to death of the first subject, the policy's maximum lifetime benefit being met, or the policy otherwise terminating. The additional subject benefit portion, however, may not reduce the policy's maximum lifetime benefit amount. The additional subject benefit may be removed from the policy if the second subject dies or if the relationship associating the couple is dissolved. For example, the additional subject benefit may be removed if the couple divorces or if the domestic partnership or civil union is dissolved.

Risk for the policy underwriter may be mitigated by requiring the first subject, who may have passed insurance underwriting requirements, to qualify for benefits based on the first subject's health. Claim administration may be simplified, for example, by multiplying the first subject's benefit payment (i.e. the first benefit) by a fixed percentage. However, it is to be understood that the present invention is not to be limited by the manner in which the additional subject benefit is determined. The second subject need not incur any covered expense and may not be required to meet any benefit eligibility criteria. Premium pricing may be based on the cost of an additional percentage of the daily benefit amount provided to the first subject.

The following is an example, consistent with an embodiment of the present invention, in which the subjects comprise a married couple and the policy involves long-term care insurance. Due to poor health or for other reasons, some individuals may not qualify for long-term care insurance or have otherwise declined to purchase long-term care insurance. If their spouses, for example, apply for and qualify for long-term care insurance, additional benefits may be paid to the primary insured of the couple consistent with embodiments of the invention. If one spouse (i.e. the uncovered spouse) does not qualify for coverage due to health, for example, the other spouse, as the primary caretaker, may be caring for the uncovered spouse. If the primary caretaker becomes ill, both spouses may need long-term care. The additional subject benefit may provide an extra sum of money, for example, to take care of the uncovered spouse in this situation should the covered spouse become ill and qualify for benefits under the policy.

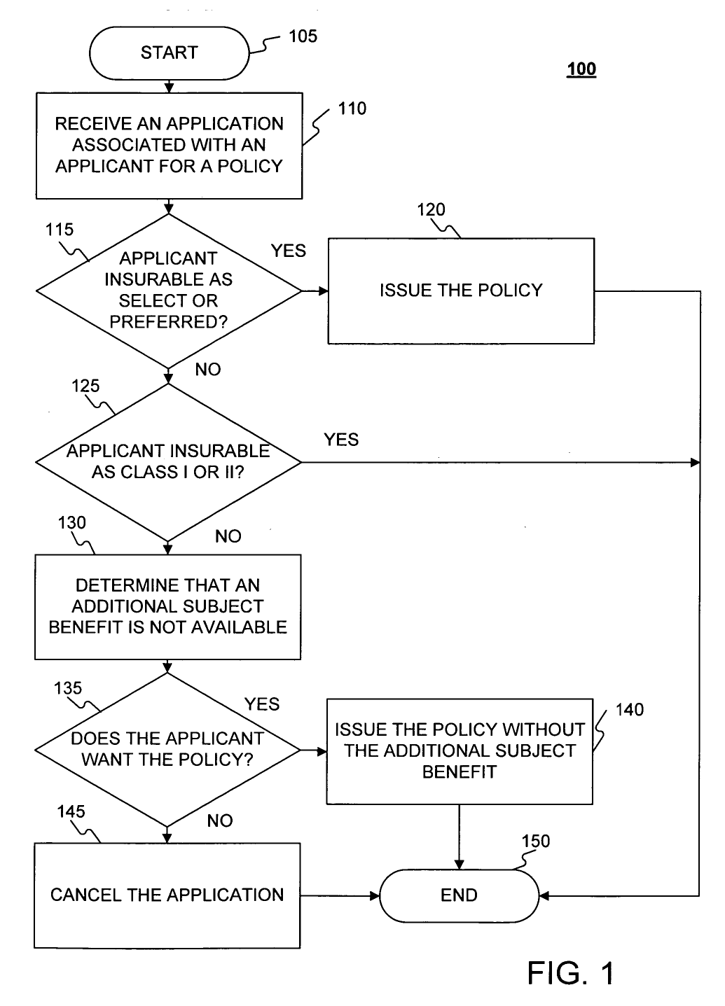

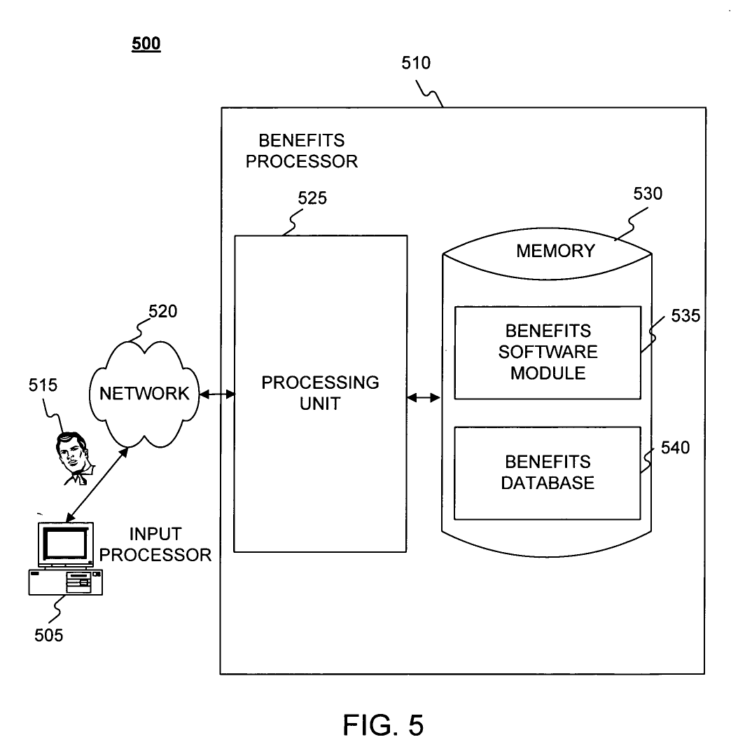

FIG. 1 is a flow chart setting forth the general stages involved in an exemplary method 100 consistent with the invention for providing a benefit using a system 500 of FIG. 5 as described below. Exemplary ways to implement the stages of exemplary method 100 will be described in greater detail below. Exemplary method 100 may begin at starting block 105 and proceed to stage 110 where a benefits processor 510 may receive an application associated with an applicant for a policy. For example, a user 515 may question the applicant and enter information corresponding to the application in an input processor 505 to create the application. The policy may comprise, but is not limited to, an insurance policy. Furthermore, the insurance policy may comprise any type of insurance policy including, but not limited to, a long-term care policy. Input processor 505 may then transmit the application associated with the applicant for the policy to benefits processor 510.

From stage 110, where benefits processor 510 receives the application associated with the applicant for the policy, exemplary method 100 may advance to decision block 115 where benefits processor 510 may determine if the applicant is insurable as select or preferred. For example, benefits processor 510 may analyze the application and determine, based on business rules for example, if the applicant may be classified as select or preferred. If the applicant may be classified as select or preferred, then the policy may be provided with additional benefits that may not be available if the applicant were not classified as select or preferred. The additional benefits may comprise, but are not limited to, additional subject benefits.

From decision block 115, if benefits processor 510 determines that the applicant is insurable as select or preferred, exemplary method 100 may proceed to stage 120 where benefits processor 510 may issue the policy. For example, benefits processor 510 may issue the policy including an additional subject benefit. If at decision block 115 benefits processor 510 determines, however, that the applicant is not insurable as select or preferred, exemplary method 100 may proceed to decision block 125 where benefits processor 510 may determine if the applicant is insurable as class I or class II. For example, if the applicant is insurable as class I or class II, then the policy may not be provided with additional benefits that may be available if the applicant were not classified as class I or class II.

From decision block 125, if benefits processor 510 determines that the applicant is not insurable as class I or class II, exemplary method 100 may proceed to stage 130 where benefits processor 510 may determine that, for example, an additional subject benefit is not available. For example, if the applicant was determined to be insurable as class I or class II, then the policy may not be provided with additional benefits.

Once benefits processor 510 determines that the additional subject benefit is not available in stage 130, exemplary method 100 may continue to decision block 135 where benefits processor 510 may determine if the applicant wants the policy. For example, if additional benefits are not available, benefits processor 510 may query the applicant over a network 520 through input processor to determine if applicant still wants the policy even if the additional benefits are not available.

From decision block 135, if benefits processor 510 determines that the applicant wants the policy, exemplary method 100 may proceed to stage 140 where benefits processor 510 may issue the policy without the additional subject benefit. If at decision block 115 benefits processor 510 determines, however, that the applicant does not want the policy, exemplary method 100 may proceed to stage 145 where benefits processor 510 may cancel the application. From stage 120, stage 140, stage 145, or decision block 125, exemplary method 100 may then end at stage 150.

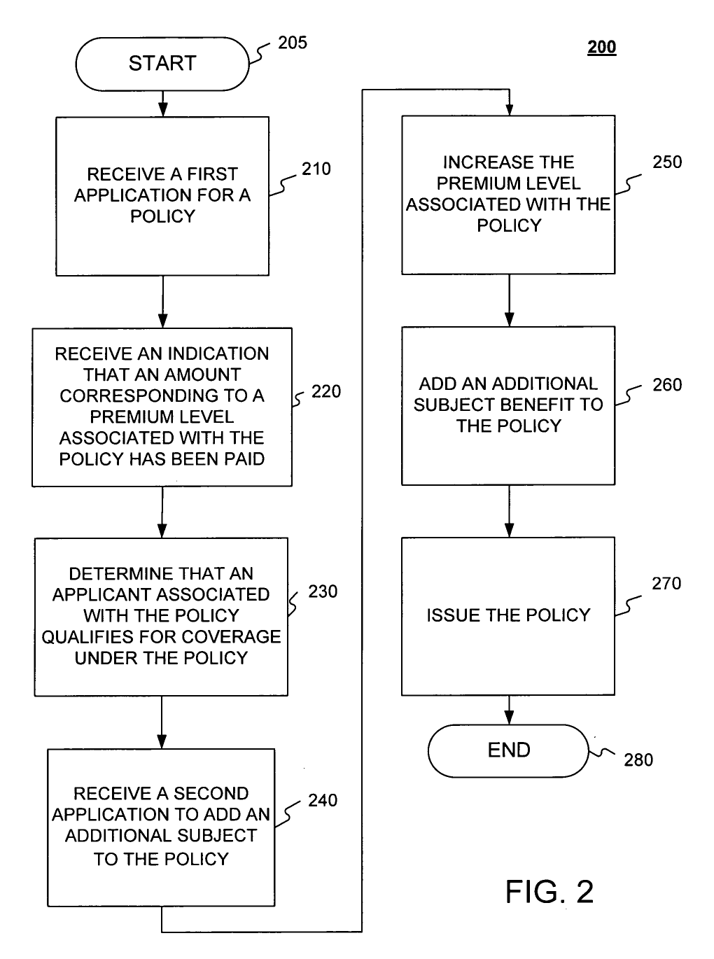

FIG. 2 is a flow chart setting forth the general stages involved in an exemplary method 200 consistent with the invention for providing a benefit using system 500 of FIG. 5. Exemplary ways to implement the stages of exemplary method 200 will be described in greater detail below. Exemplary method 200 may begin at starting block 205 and proceed to stage 210 where benefits processor 510 may receive a first application for a policy. For example, benefits processor 510 may receive an application, for a long-term care insurance policy from input processor 505 over network 520.

From stage 210, where benefits processor 510 receives the first application for the policy, exemplary method 200 may advance to stage 220 where benefits processor 510 may receive an indication that an amount corresponding to a premium level associated with the policy has been paid. For example, benefits processor 510 may receive an indication that an applicant has paid the premium associated with the policy. The application, for example, may comprise a first subject of a couple comprising the first subject and a second subject.

Once benefits processor 510 receives the indication in stage 220, exemplary method 200 may continue to stage 230 where benefits processor 510 may determine that an applicant associated with the policy qualifies for coverage under the policy. For example, benefits processor 510 may analyze the application and apply business rules stored in benefits database 540 to determine whether the applicant qualifies for coverage under the policy.

After benefits processor 510 determines that the applicant associated with the policy qualifies for coverage in stage 230, exemplary method 200 may proceed to stage 240 where benefits processor 510 may receive an application to add an additional subject to the policy. For example, benefits processor 510 may receive an application from input processor 505 over network 520, for example, to add an additional subject to the long-term care insurance policy. The additional subject may comprise the second subject of the couple.

From stage 240, where benefits processor 510 receives the application to add the additional subject to the policy, exemplary method 200 may advance to stage 250 where benefits processor 510 may increase the premium level associated with the policy. For example, because the application to add the additional subject to the policy has been received, the aforementioned premium level may be increased. The first subject may have qualified for benefits based on the first subject's health. The second subject may not be required to meet any benefit eligibility criteria in order to have the additional subject benefit added to the policy. Pricing (i.e. the increased premium level) may be based on a cost of an additional percentage of a daily benefit amount provided to the first subject.

Once benefits processor 510 increases the premium level in stage 250, exemplary method 200 may continue to stage 260 where benefits processor 510 may add an additional subject benefit to the policy. For example, the name of the second subject of the couple may be added to the policy under an additional subject benefit provision. When the first subject (i.e. primary insured) qualifies for benefits under the policy, an additional subject benefit may add an additional percentage (e.g. 60%) to the applicable daily or monthly benefit amount payment. For example, if the first subject is to receive a $1,000 monthly benefit, the additional subject benefit may provide an additional $600 for a total of $1,600. The entire benefit amount, including the additional subject benefit portion, may be included in one check payable to, for example, the first subject. The additional subject benefit may continue as long as benefits are being paid to the first subject until death of the first subject, until divorce or dissolution of the couple, or until the policy terminates. The additional percentage benefit may not reduce the policy's maximum lifetime benefit amount.

After benefits processor 510 adds the additional subject benefit to the policy in stage 260, exemplary method 200 may proceed to stage 270 where benefits processor 510 may issue the policy. For example, an insurance underwriter associated with benefits processor 510 may issue the policy (e.g. long-term care insurance) including the additional subject benefit. After benefits processor 510 issues the policy in stage 270, exemplary method 200 may then end at stage 280.

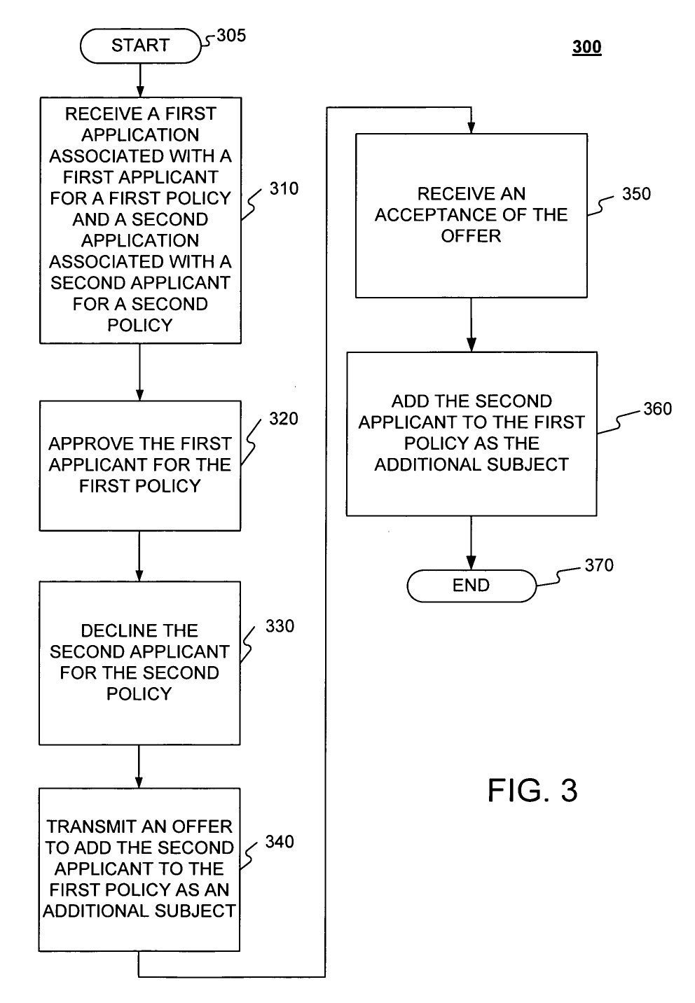

FIG. 3 is a flow chart setting forth the general stages involved in an exemplary method 300 consistent with the invention for providing a benefit using system 500 of FIG. 5. Exemplary ways to implement the stages of exemplary method 300 will be described in greater detail below. Exemplary method 300 may begin at starting block 305 and proceed to stage 310 where benefits processor 510 may receive a first application associated with a first applicant for a first policy and a second application associated with a second applicant for a second policy. For example, benefits processor 510 may receive the first application and the second application for long-term care insurance policies from input processor 505 over network 520. The first applicant may comprise a first subject and the second applicant may comprise a second subject. The first and second subjects together may comprise any type of associated couple, including, but not limited to a married couple, a domestic partnership, or a civil union.

From stage 310, where benefits processor 510 may receive the first and second applications, exemplary method 300 may advance to stage 320 where benefits processor 510 may approve the first applicant for the first policy. For example, the first applicant's approval may be based on the first subject passing insurance underwriting requirements and may be based on the first subject passing a physical health test.

Once benefits processor 510 approves the first applicant in stage 320, exemplary method 300 may continue to stage 330 where benefits processor 510 may decline the second applicant for the second policy. For example, the second applicant's declination may be based on the second subject failing insurance underwriting requirements or may be based on the second subject failing a physical health test.

After benefits processor 510 declines the second applicant for the second policy in stage 330, exemplary method 300 may proceed to stage 340 where benefits processor 510 may transmit an offer to add the second applicant to the first policy as an additional subject. For example, benefits processor 510 may transmit the offer to input processor 505 where the offer may in turn be made known to the first applicant. For example, an agent (e.g. user 515) may be providing a sales presentation to the first applicant and the second applicant. If the second applicant is declined, the agent may lose the sale and the first applicant may desire to shop around for coverage even though the first applicant was approved. To prevent the first and second applicants from shopping around, the agent may be authorized to offer to add the second applicant to the first policy as the additional subject.

From stage 340, where benefits processor 510 transmits the offer to add the second applicant to the first policy, exemplary method 300 may advance to stage 350 where benefits processor 510 may receive an acceptance of the offer. For example, after considering the offer, the first applicant may accept the offer. The acceptance may be transmitted from input processor 505 over network 520 to benefits processor 510. There may be no medical underwriting to add the second applicant to the first policy. Rather, the second applicant may automatically be added as part of the first applicant's policy. In this way, the first and second applicants may at least in some way have protection for long term care for both applicants should the first applicant qualify for benefits.

Once benefits processor 510 receives the acceptance of the offer in stage 350, exemplary method 300 may continue to stage 360 where benefits processor 510 may add the second applicant to the first policy as the additional subject. For example, because of health or for other reasons, the second applicant may not qualify for long-term care insurance or may have declined to purchase long-term care insurance. If the first applicant, for example, applies for and qualifies for long-term care insurance, additional benefits may be paid to the first applicant (i.e. the primary insured) consistent with embodiments of the invention. In other words, if the second subject does not qualify for coverage due to health, for example, the first subject, as the primary caretaker, may be caring for the uncovered couple member. If the first subject becomes ill, both couple members may need long-term care. The additional subject benefit may provide an extra sum of money, for example, to take care of the uncovered couple member in this situation.

The additional subject benefit may comprise cash to use for any purposes the first applicant wants. For example, in preparing the first application, the agent may “check the box” that says “additional subject benefit”, run a proposal for rates, and put the second applicant's name in the first application so the underwriter knows who the second applicant is. No medical qualification may be required for the second subject. Accordingly, an extra premium may be charged for the additional subject benefit and the benefit may be paid as long as the first applicant qualifies for the benefit and the second applicant is alive and associated with the first applicant as defined by the policy. Such associations between the first applicant and the second applicant may comprise, but not limited to a marriage, a domestic partnership, or a civil union. The aforementioned are exemplary, and the first applicant and the second applicant may comprise any type of association.

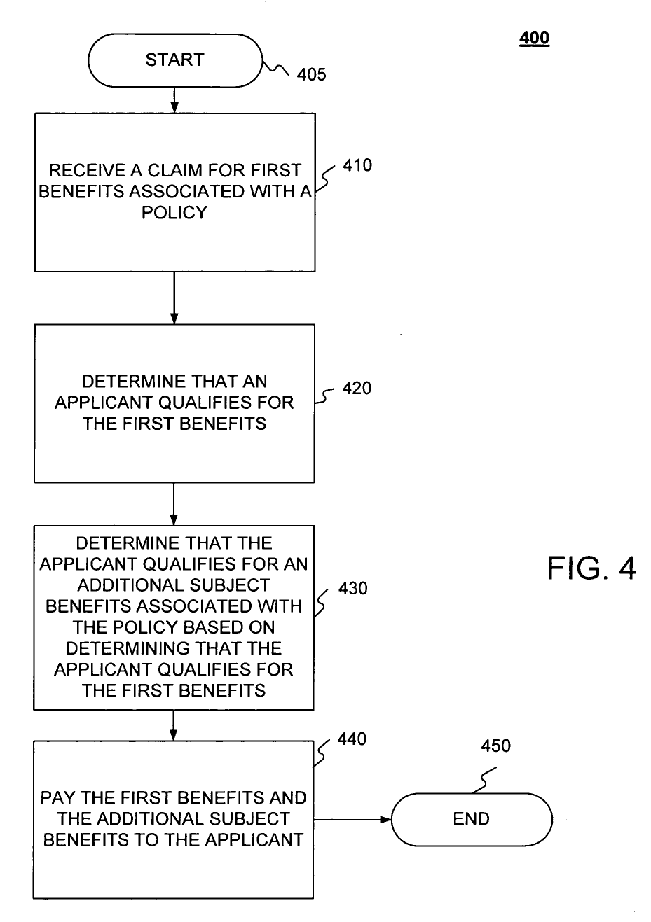

FIG. 4 is a flow chart setting forth the general stages involved in an exemplary method 400 consistent with the invention for providing a benefit using system 500 of FIG. 5. Exemplary ways to implement the stages of exemplary method 400 will be described in greater detail below. Exemplary method 400 may begin at starting block 405 and proceed to stage 410 where benefits processor 510 may receive a claim for first benefits associated with a policy. For example, the applicant may submit a claim for benefits under the policy through input processor 505 over network 520.

From stage 410, where benefits processor 510 receives the claim, exemplary method 400 may advance to stage 420 where benefits processor 510 may determine that an applicant qualifies for the first benefits. For example, benefits processor 510, using business rules in benefits database 540, may analyze the claim. The claim analysis may indicate that the applicant qualifies for the first benefit.

Once benefits processor 510 determines that the applicant qualifies for the first benefits in stage 420, exemplary method 400 may continue to stage 430 where benefits processor 510 may determine that the applicant qualifies for additional subject benefits associated with the policy based on determining that the applicant qualifies for the first benefits. For example, when the applicant (i.e. the first subject) qualifies for benefits under the policy, an additional subject benefit may add an additional percentage (e.g. 60%) to the applicable daily or monthly benefit amount payment (i.e., the first benefit.) For example, if the applicant receives a $1,000 monthly first benefit, the additional subject benefit may provide an additional $600 for a total of $1,600.

After benefits processor 510 determines that the applicant qualifies for the additional subject benefits in stage 430, exemplary method 400 may proceed to stage 440 where benefits processor 510 may pay the first benefits and the additional subject benefits to the applicant. For example, the entire benefit amount, including the first benefits and the additional subject benefit portion, may be included in one check payable to, for example, the applicant. The additional subject benefit may continue as long as benefits are being paid to the applicant, for example, until death of the applicant, until divorce or dissolution of the couple, or until the policy terminates. The additional percentage benefit may not reduce the policy's maximum lifetime benefit amount. After benefits processor 510 pays the first benefits and the additional subject benefits in stage 440, exemplary method 400 may then end at stage 450.

An embodiment consistent with the invention may comprise a system for providing an additional subject benefit. The system may comprise a memory storage for maintaining a database and a processing unit coupled to the memory storage. The processing unit may be operative, for example, to perform any one or more of the functions described above. The aforementioned functions are exemplary and the processing unit may be operative to perform any functions.

Consistent with an embodiment of the present invention, the aforementioned memory, processing unit, and other components may be implemented in a benefits system, such as exemplary benefits system 500 of FIG. 5. Any suitable combination of hardware, software, and/or firmware may be used to implement the memory, processing unit, or other components. By way of example, the memory, processing unit, or other components may be implemented with any of input processor 505 or benefits processor 510, in combination with system 500. The aforementioned system and processors are exemplary and other systems and processors may comprise the aforementioned memory, processing unit, or other components, consistent with embodiments of the present invention.

By way of a non-limiting example, FIG. 5 illustrates system 500 in which the features and principles of the present invention may be implemented. As illustrated in the block diagram of FIG. 5, system 500 may include input processor 505, benefits processor 510, user 515, and network 520. User 515 may be an individual, for example, desiring to propose or provide a benefit using benefits processor 510. For example, user 515 may be an insurance agent or may be an individual seeking to obtain a benefit for his or herself. User 515 may also be an organization, enterprise, or any other entity having such desires. Input processor 505, for example, may be located at an insurance agent's office or may comprise a computer under the control of an individual seeking to obtain a benefit for his or herself. Benefits processor 510, for example, may be located at the headquarters of an insurance underwriter granting the policy or otherwise be under the control of an insurance underwriter granting the policy.

As shown in FIG. 5, benefits processor 510 may include a processing unit 525 and a memory 530. Memory 530 may include a benefits software module 535 and a benefits database 540. While executing on processing unit 525, benefits software module 535 may perform processes for providing benefits, including, for example, one or more of the stages described in exemplary method 100, 200, 300, and/or 400 as described above with respect to FIG. 1, FIG. 2, FIG. 3, and/or FIG. 4. The aforementioned are exemplary and benefits software module 535 may perform other processes. Furthermore, any combination of software module 535 and database 540 may be executed on or reside in any one or more of processors 505 or 510 as shown in FIG. 5.

Input processor 505 or benefits processor 510 (“the processors”) included in system 500 may be implemented using a personal computer, network computer, mainframe, or other similar microcomputer-based workstation. The processors may though comprise any type of computer operating environment, such as hand-held devices, multiprocessor systems, microprocessor-based or programmable sender electronic devices, minicomputers, mainframe computers, and the like. The processors may also be practiced in distributed computing environments where tasks are performed by remote processing devices. Furthermore, any of the processors may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processor may comprise other systems or devices.

Network 520 may comprise, for example, a local area network (LAN) or a wide area network (WAN). Such networking environments are commonplace in offices, enterprise-wide computer networks, intranets, and the Internet. When a LAN is used as network 520, a network interface located at any of the processors may be used to interconnect any of the processors. When network 520 is implemented in a WAN networking environment, such as the Internet, the processors may typically include an internal or external modem (not shown) or other means for establishing communications over the WAN. Further, in utilizing network 520, data sent over network 520 may be encrypted to insure data security by using known encryption/decryption techniques.

In addition to utilizing a wire line communications system as network 520, a wireless communications system, or a combination of wire line and wireless may be utilized as network 520 in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The processors in the wireless environment can be any mobile terminal, such as the mobile terminals described above. Wireless data may include, but is not limited to, paging, text messaging, e-mail, Internet access and other specialized data applications specifically excluding or including voice transmission. For example, the processors may communicate across a wireless interface such as, for example, a cellular interface (e.g., general packet radio system (GPRS), enhanced data rates for global evolution (EDGE), global system for mobile communications (GSM)), a wireless local area network interface (e.g., WLAN, IEEE 802.11), a bluetooth interface, another RF communication interface, and/or an optical interface.

System 500 may also transmit data by methods and processes other than, or in combination with, network 520. These methods and processes may include, but are not limited to, transferring data via, diskette, flash memory sticks, CD ROM, facsimile, conventional mail, an interactive voice response system (IVR), or via voice over a publicly switched telephone network.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

The present invention may be embodied as systems, methods, and/or computer program products. Accordingly, the present invention may be embodied in hardware and/or in software (including firmware, resident software, micro-code, etc.). Furthermore, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention are described above with reference to block diagrams and/or operational illustrations of methods, systems, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

While certain features and embodiments of the invention have been described, other embodiments of the invention may exist. Furthermore, although embodiments of the present invention have been described as being associated with data stored in memory and other storage mediums, aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A method for providing an additional subject benefit, the method comprising:
determining if the additional subject benefit is available based on an analysis of an application;
issuing an insurance policy with the additional subject benefit if it was determined that the additional subject benefit is available;
receiving data indicating a response of an applicant to the additional subject benefit not being available if it was determined that the addition subject benefit is not available; and
issuing the insurance policy without the additional subject benefit if the received data indicates that the applicant wants the policy without the additional subject benefit.

2. The method of claim 1, further comprising receiving the application associated with the applicant for the policy.

3. The method of claim 1, further comprising canceling the application if the received data indicates that the applicant does not want the policy without the additional subject benefit.

4. The method of claim 1, further comprising, if the policy issues with the additional subject benefit, provisioning the policy with a maximum lifetime limit wherein the additional subject benefit does not count against the maximum lifetime benefit.

5. The method of claim 1, wherein the policy comprises a long-term care policy.

6. The method of claim 1, further comprising provisioning the policy to stop paying all benefits when the applicant no longer qualifies for benefits under the policy.

7. The method of claim 1, further comprising provisioning the policy to stop paying all benefits when the applicant no longer qualifies for benefits under the policy due to at least one of the following: death of the applicant; the policy's maximum lifetime benefit being met; and the policy terminates.

8. The method of claim 1, further comprising, if the policy issues with the additional subject benefit, provisioning the policy to stop paying the additional subject benefit when at least one of the following occurs: an additional subject dies and a relationship associating the applicant and the additional subject is dissolved.

9. A method for providing an additional subject benefit, the method comprising:
determining that an applicant associated with a policy qualifies for coverage under the policy;
receiving a second application to add an additional subject to the policy;
increasing a premium level associated with the policy; and
adding the additional subject benefit to the policy.

10. The method of claim 9, further comprising receiving an indication that an amount corresponding to the premium level associated with the policy has been paid.

11. The method of claim 9, further comprising issuing the policy.

12. The method of claim 9, further comprising provisioning the policy with a maximum lifetime limit wherein the additional subject benefit does not count against the maximum lifetime benefit.

13. The method of claim 9, wherein determining that the applicant associated with the policy qualifies for coverage under the policy further comprises determining that the applicant associated with the policy qualifies for coverage under the policy comprising a long-term care policy.

14. The method of claim 9, further comprising provisioning the policy to stop paying all benefits when the applicant no longer qualifies for benefits under the policy.

15. The method of claim 9, further comprising provisioning the policy to stop paying all benefits when the applicant no longer qualifies for benefits under the policy due to at least one of the following: death of the applicant; the policy's maximum lifetime benefit being met; and the policy terminates.

16. A method for providing an additional subject benefit, the method comprising:
receiving a first application associated with a first applicant for a first policy and a second application associated with a second applicant for a second policy;
approving the first applicant for the first policy;
declining the second applicant for the second policy;
transmitting an offer to add the second applicant to the first policy as an additional subject;
receiving an acceptance of the offer; and
adding the second applicant to the first policy as the additional subject.

17. The method of claim 16, wherein receiving the first application associated with the first applicant for the first policy and the second application associated with the second applicant for the second policy further comprises receiving the first application associated with the first applicant for the first policy comprising a first long-term care policy and the second application associated with the second applicant for the second policy comprising a second long-term care policy.

18. The method of claim 16, further comprising provisioning the first policy to stop paying all benefits when the first applicant no longer qualifies for benefits under the first policy.

19. The method of claim 16, further comprising provisioning the first policy to stop paying all benefits when the first applicant no longer qualifies for benefits under the first policy due to at least one of the following: death of the first applicant; the first policy's maximum lifetime benefit being met; and the first policy terminates.

20. The method of claim 16, further comprising provisioning the first policy to stop paying the additional subject benefit when at least one of the following occurs: the second applicant dies and a relationship associating the first applicant and the second applicant is dissolved.

21. The method of claim 16, wherein receiving the first application associated with the first applicant for the first policy and the second application associated with the second applicant for the second policy further includes the first applicant and the second applicant being related at least one of the following: marriage; domestic partnership; and civil union.

22. A method for providing an additional subject benefit, the method comprising:
receiving a claim for a first benefit associated with a policy;
determining that an applicant qualifies for the first benefit; and
determining that the applicant qualifies for the additional subject benefit associated with the policy based on determining that the applicant qualifies for the first benefit.

23. The method of claim 22, further comprising paying the first benefit and the additional subject benefit to the applicant.

24. A computer-readable medium which stores a set of instructions which when executed performs a method for providing an additional subject benefit, the method executed by the set of instructions comprising:
determining if the additional subject benefit is available based on an analysis of an application;
issuing the policy with the additional subject benefit if it was determined that the additional subject benefit is available;
receiving data indicating a response of an applicant to the additional subject benefit not being available if it was determined that the addition subject benefit is not available; and
issuing the policy without the additional subject benefit if the received data indicates that the applicant wants the policy without the additional subject benefit.

25. A computer-readable medium which stores a set of instructions which when executed performs a method for providing an additional subject benefit, the method executed by the set of instructions comprising:
determining that an applicant associated with a policy qualifies for coverage under the policy;
receiving a second application to add an additional subject to the policy;
increasing a premium level associated with the policy; and
adding the additional subject benefit to the policy.
